(19) United States
(12) Patent Application Publication
(10) Pub. No.: US 2006/0116991 A1
(43) Pub. Date: Jun. 1, 2006

(54) Remote database technique

(75) Inventor: Alastair Calderwood, London (GB)

Correspondence Address: MCDERMOTT, WILL & EMERY (LOS ANGELES OFFICE), 2049 CENTURY PARK EAST, 34TH FLOOR, LOS ANGELES, CA, 90067-3208, US

(73) Assignee: Ciphergrid Limited

(21) Appl. No.: 11/249,529

(22) Filed: Oct. 13, 2005

(30) Foreign Application Priority Data
Oct. 13, 2004 (GB) GB0422750.0

(51) Int. Cl. G06F 17/30

(52) U.S. Cl. 707/3

(57) ABSTRACT

Systems, methods, software applications and virtual machines for creating, holding, referencing and/or accessing data objects from an application on a remote machine. The system allows a software application to read, write and perform transactions using data stored in one or more distributed databases. Methods are described for accessing a data object of a resource from an application located remotely from the resource. Methods are also described for issuing and servicing a method call from an application to a data object in a remote database. A virtual machine is yet further described for running a software application implemented using an object-oriented language for performing an operation on a plurality of data objects of a remote virtual machine. Still further described is a software application implemented using an object-oriented language to instantiate, store and access data objects on a remote virtual machine.

### CROSS-REFERENCE TO RELATED APPLICATIONS

This application claims the benefit of priority under 35 U.S.C. § 119 from United Kingdom Patent Application No. 0422750.0, filed Oct. 13, 2004, entitled “Remote Database Technique.” The entire content of this application is incorporated herein by reference.

### FIELD OF THE INVENTION

The invention relates to methods and systems concerning remote database techniques.

A preferred embodiment relates to a method, system and computer program product for accelerated transactional access from a pre-existent application to a database by means of a pre-existent driver installed on a machine remote to the application.

### BACKGROUND OF THE INVENTION

A computer database is a collection of data records. Typically, when an application program requests access to a record in the database, it calls a method in a database driver, which consults the database and encapsulates a certain aspect thereof in an object that may be used by processes of the application. There is a network connection between the driver and the database, which is also represented by an object available to the application. It is good practice to make this connection as fast as possible, since in most existing systems it carries large amounts of data and thereby uses considerable network bandwidth. The Internet allows network connections to connect machines regardless of distance, but where the connection carries data, performance degradation can be critical.

It has been established that most known techniques for accessing remote databases generally fall into one of three categories.

In a first category of known techniques, the database driver and application are installed on machines sharing the same private, local network, and the application is responsible for managing a connection from the database driver to the remote database. This connection is often very slow, and for an application with multiple users, it can be difficult to manage more than one connection.

In a second category of known techniques, the database driver and database are remote to the application, and a component interacts with the database driver to make the data available by means a particular technique whereby object methods can be called from a remote machine. However, the application must have been written with this kind of object in mind, and adapting existing applications is problematic. This also introduces needless complexity to the application, drawing the developer's attention away from its core logic. Furthermore, performance is adversely affected.

In a third category of known techniques, the database is replicated, integrated with another database, or otherwise made available on the same network as the application. This is the best previous solution, but there can still be performance issues. Furthermore, the security privileges of a database that was intended for one closed network must then be set up again by a different party on another network. The solution is unlikely to be applied if the database and application reside in different organisations.

Prior art has been researched through analysis of commonly applied techniques and individual patents. This research indicates that there are known methods and systems relating to database management. See Table 1, hereinafter.

One known technique for performing operations on remote objects, Remote Method Invocation (Remote Method Invocation is part of the Java™ Standard Edition specification published by Sun Microsystems), uses a mechanism for referencing remote objects located internally in particular classes, which must be written into the program. In the present invention, the remote reference mechanism is in a different component, external to the classes to be accessed.

WO 03/107205 entitled “A distributed object middleware linkage method, recording medium containing program, and program” explains a mechanism for storing client references to server objects on different machines. In order to call a method, a “relay object” must be explicitly sent to the server object in order to gather information about methods of the class.

One skilled in the art whose brief is to deploy a system providing an application with the ability to access a remote database driver would probably consider one of the five.

First, one might consider installing the database driver on the same client machine as the application and accessing the database via a network connection from the driver. This is simple to deploy, but results returned from the database may exceed the data capacity of the network connection.

Second, one might consider replicating the remote database on the local network, and using a synchronisation mechanism to ensure the two databases remain as copies. This technique would ensure that a local copy of the database is then available, but replicating a database between different organisations may not always be possible.

Third, one might consider merging the remote database into a local database. The database is now local, but if the databases to be merged are managed by different parties, it may be difficult to persuade the manager of the remote database to replicate it on a different network.

Fourth, one might consider writing a component with a remote interface calling key methods in the database driver, and altering the application to call the remote interfaces of this component. The database driver can then be accessed remotely, but the application will need to be altered.

Fifth, one might consider installing the database driver on a server machine close to the database and making the data available as CORBA or RMI objects. Such objects, however, cannot be accessed as easily as standard objects.

Prior Art patent documents are mentioned in Table 1, below.

TABLE 1
Prior Art Patent Documents

| Title | Patent No. | Applicant(s) | City | Granted |
|---|---|---|---|---|
| Method and system | US2002199035 | Lovering, | US | 26th |
| for remote | | Bradford H; | | Dec, |
| automation of object | | Christensen, | | 2002 |
| oriented applications | | Erik B. | | |
| Distributed object | US2003009539 | NTT Software | US | 9th |
| middleware | | Corp. | | Jan, |
| connection method | | | | 2003 |
| Global database | US2004083223 | Cui, Zhan; | US | 29th |
| management system | | Jones, Dean | | Apr, |
| integrating | | M. | | 2004 |
| heterogeneous data | | | | |
| resources | | | | |
| Method and system | US2004088298 | Zhu, Zeng; | US | 6th |
| for managing a | | Zou, Kevin; | | May, |
| distributed | | Wiles, Josh A; | | 2004 |
| transaction process | | Solitro, | | |
| | | Pasquale | | |
| System and method | US2004088717 | Coppens, | US | 6th |
| for connectivity to | | Peter; Chen, | | May, |
| structured query | | Jun; | | 2004 |
| language database | | Goodson, | | |
| | | John | | |
| Approach for | US6738790 | Oracle Corp. | US | 18th |
| accessing large | | | | May, |
| objects | | | | 2004 |
| Distributed object | WO03107205 | NTT Software | JP | 24th |
| middleware linkage | | Corp. | | Dec, |
| method, recording | | | | 2003 |
| medium containing | | | | |
| program, and | | | | |
| program | | | | |
| Database accelerator | WO2004036432 | Annex | JP | 29th |
| | | Systems Inc.; | | Apr, |
| | | Tamatsu | | 2004 |
| | | Masaharu | | |

US Patent No. 2002199035; Method and System for Remote Automation of Object-Oriented Applications

This prior art discloses a method and system that is an extension of the Object Linking and Embedding (OLE) mechanism by Microsoft Corp. whereby a stub and proxy may be provided for a particular object. Using OLE, the application communicates with the proxy, which in turn passes method calls via a communication channel to the stub. Proxy and stub may be on different machines with non-shared memory, but are limited to a single client and a single server machine.

A problem with this prior art system is that reference logic is acquired from a mechanism within a particular type of server object, as is the case for the stub/skeleton mechanisms of Remote Procedure Calls and Remote Method Invocation. This limits its application to components that have been designed specifically for remote access.

US Patent No. 2003009539; Distributed Object Middleware Connection Method

This prior art discloses a method for performing a method call from an object in a client on an existing object in a server, when communication protocols of distributed object middlewares in the client and in the server are different. In particular, it enables interoperability between different Object Request Broker (ORB) protocols such as RMI and CORBA, using different communication protocols such as SOAP and IIOP.

This prior art does not relate to a new remote access system for objects, but instead to a system allowing existing ORB protocols to communicate. The ORB protocols require objects to be of a special type implementing a remote procedure call interface. Information about an object's class is registered in and looked up in a naming registry accessible to both client and server.

US Patent No. 2004083223; Global Database Management System Integrating Heterogeneous Data Resources

The prior art relates to a database management system for resolving distributed queries across a range of resources. A query engine is designed to consult the server so that it can construct a query that will operate effectively across the disparate database resources.

The system cited relates solely to database management. It does not relate to an application or process manipulating data in the database. A further problem is that the system disclosed supports only database queries.

US Patent No. 2004088298; Method and System for Managing a Distributed Transaction Process

This prior art discloses systems and methods for managing a distributed transaction process include various transaction managers. A distributed transaction may span a number of databases, or may operate on a single merged database, comprising elements of different databases. A merge manager determines whether to transfer control of the merge database to the active transaction manager.

A problem is that the systems and methods cited include a database merge manager, which may under certain circumstances transfer transaction control from a number of disparate databases, each of which has its own administrator, to a single merged database, with a single administrator. Embodiments of the present invention do not transfer the control of transactions in this way.

US Patent No. 2004088717; System and Method for Connectivity to Structured Query Language Database

This prior art discloses a system and method for conducting distributed transactions wherein a connect JDBC® driver for a particular server implements Java™ JTA distributed transactions in the driver. During communication, the JDBC® driver may request information from the server, or instruct the server to perform an operation.

This system and method refer to objects on the machine on which an application server is running, which in practice performs transactions only with local databases. This is not because it is not possible to connect to databases on remote networks using the normal procedure of direct database connection, but the associated latency (reduction in performance incurred) would then make many transactions unworkable in practice. Hence transactions, in this prior art system and method, are in practice distributed across a local area network and do not refer to transactions with databases on remote networks.

U.S. Pat. No. 6,738,790; An Approach for Accessing Large Objects

This prior art discloses a method and system for accessing a large “object” that belongs to a cell in a table, whereby an index is built on a column in which the large object resides, and the index has a key including a large object identifier. A database server receiving a request to access the large object is able to follow the address contained in the index entry to a storage device containing a portion of the large object. The term object, however, here refers to data in a table cell as opposed to an object of an object-oriented language. The address referred to in the prior art cited is a static storage address which must be entered in the index, and is then bound to the contents of a single table cell.

WO 03/107205; A Distributed Object Middleware Linkage Method, Recording Medium Containing Program, and Program

This prior art relates to a method executed in a computer provided between a client and server, which allows remote references to pre-existing objects and class methods to be acquired and used remotely. Relay objects are used to first obtain information about methods in a server object before it is executed. The reference logic is acquired from a mechanism within a particular type of server object, as is the case for the stub/skeleton mechanisms of remote procedure calls and remote method invocation (both of which have open, published and apparently unpatented specifications). This limits its application to components that have been designed specifically for remote access.

Objects conforming to a micro-specification (which is itself defined and described in the same patent) may be accessed remotely; in the present invention, any object belonging to the API of a component conforming to a common specification (itself outside the scope of this patent) may be accessed remotely.

WO 2004036432; Database Accelerator

This prior art discloses a technique whereby a database location table is present on a primary system, and a number of synchronised location tables on an accelerator system. Processing requests may be distributed to the accelerator system for processing in alternative locations. The system relates to proxy information held in database tables, whereas embodiments of the present invention relates to objects in an object-oriented language.

Embodiments of the present invention do not attempt to use, improve or optimise any of the methods contained in the above categories.

Based on the foregoing, no known solution provides two-way communication between an existing application and a remote database driver, through a connection whose security privileges are set by the database's administrator.

Embodiments of the present invention seek to provide improved systems, methods, computer programs and products.

### SUMMARY

According to one aspect of the present invention there is a method for accessing a data object of a resource from an application located remotely from the resource, the method comprising: issuing a method call from the application; receiving the issued method call at a proxy driver located remotely from the resource; generating a proxy command comprising a reference to the corresponding data object; sending the proxy command over a communication channel to the resource; and accessing the data object of the resource based on the proxy command.

Preferably, wherein the communication channel provides two-way communication between an application and the remote resource so that commands can be sent and received over the channel.

Preferably, wherein the communication channel is a TCP/IP link.

Preferably, wherein the application and proxy driver are located in a client computer and the remote resource located is located in a server computer.

Preferably, wherein the server computer comprises a bridge for receiving the proxy commands sent to the resource.

Preferably, wherein the bridge is capable of operating in a synchronous mode whereby the command awaits a return of a result from the resource before a new command is generated.

Preferably, wherein the bridge is capable of operating in an asynchronous mode whereby the step of generating a new command does not depend on a return of the result of the previous command

Preferably, wherein the server computer also comprises a database proxy with interface between the bridge and resource.

Preferably, wherein the client computer also comprises an interface associated with the proxy driver, said interface is the same as that of the database driver, and wherein both meet the same specification, which is a DBC API interface,

Preferably, wherein the resource is a database.

Preferably, wherein the data object is of a class that belongs to a same specification of an interface associated with a database driver located remotely from the specification.

Preferably, wherein the proxy command generated includes the properties of the method call.

Preferably, wherein each method call sent across the interface is wrapped in a format that allows serialization/deserialization and forwarding across a wire protocol.

Preferably, wherein the proxy component is accessed from the application through the same method call on a same class that the application would make if it were calling the resource directly, and wherein the method call having a signature that specifies a return type.

Preferably, wherein the bridge comprises a registry for storing data objects returned by the resource accessed by the application and for indexing the data objects by means of a unique key.

Preferably, wherein each data object is synchronized with its corresponding proxy data object by means of a numerical reference, which is held both as an attribute of the proxy data object and an index key in the registry.

Preferably, wherein the application and proxy driver are located in a first communication network and the resource is located in a second network, said first and second networks being connected by the communication channel.

Preferably, wherein the communication channel comprises security privileges determined by an administrator of the database.

Preferably, wherein each method call is: converted to a form suitable for sending across a communication protocol for a channel; wrapped in an object, together with an index reference to the object to which the method call was made; serializing the wrapped object; sending to the bridge; deserialized and unwrapped, and wherein information contained therein is converted to a method object that may be invoked using an established reflection mechanism.

According to a further aspect of the present invention there is a virtual machine running a software application implemented using an object-oriented language for performing an operation on a plurality of data objects of a remote virtual machine, the application comprising a memory arranged to store a plurality of proxy data objects each of which corresponding to the data objects of the remote virtual machine and implementing an interface which is the same as that for the remote data objects, wherein the application is arranged to call methods on the proxy data objects, which perform the operation on the data objects of the remote virtual machine.

Preferably, wherein the interfaces conform to a specific database connectivity specification having classes that are implemented in a pre-existing database driver.

Preferably, wherein the interface of the database driver on the remote virtual machine is the same as the interface accessible by the virtual machine running the software application, both being defined by the database connectivity specification.

Preferably, wherein the operation performed is capable of instantiating a new data object, operating on or consulting an existing data object.

Preferably, wherein the operation performed is capable of returning data objects, non-data objects and values to the application.

Preferably, wherein the remote virtual machine comprises a bridge having a registry where the data objects are capable of being looked up, extracted from and returned to the registry using an index reference.

Preferably, wherein the each of the data objects is synchronized with said corresponding proxy objects by a numerical reference, which is held both as an attribute of the proxy data object and as said index reference for the registry.

Preferably, wherein look-ups of the registry are performed using the index reference held in the corresponding proxy data object.

Preferably, wherein each proxy data object is smaller than the corresponding data object.

Preferably, wherein each proxy data object comprises a reference to the corresponding data object.

According to yet another aspect of the present invention there is provided a software application implemented using an object-oriented language to instantiate, store and access data objects on a remote virtual machine, the software application runs on a second virtual machine distinct from the remote virtual machine, and connected thereto by means of TCP/IP, wherein the application having an proxy interface and the remote virtual machine having a database interface that conforms to a specific database connectivity specification having classes implemented in a pre-existing database driver.

According to yet another aspect of the present invention there is provided a system for allowing an application to access a data object in a remote database, wherein a proxy driver component, also located remotely from the remote database, is accessed from the application program through a method call on a same class that the application would make if it were calling the remote database driver directly, wherein subsequent application code will require a return type specified in the signature.

According to yet another aspect of the present invention there is provided a method of issuing and servicing a method call from an application to a data object in a remote database, wherein a proxy driver and bridge reside close to the application and database respectively, and wherein the proxy driver component is accessed from the application through the same method call on a same class that the application would make if it were calling the database driver directly.

According to yet another aspect of the present invention there is provided a system for accessing remote data objects, the system comprising: a first machine comprising an application and a proxy driver with an interface, wherein the interface receiving method calls from the application; a network connecting the first machine to a second machine; the second machine comprising a bridge, a database driver with an interface and a database, wherein the bridge storing data objects returned by the database driver from the database in response to previous method calls and the bridge further comprising a registry with an index reference to the data objects stored in the bridge.

Preferably, wherein the proxy driver with interface and the database driver with interface meet the same specification, which is a DBC API, and wherein such an arrangement allows the application using an object-oriented language to read, write to, manipulate and return results from the database using objects of said language.

Preferably, wherein a new data object of a certain class is created and returned by the database driver having the same class, and is stored in the bridge of the second machine, said bridge returning a unique reference of the new data object to the proxy driver on the first machine, thereby allowing the new data object to accessed by the application as if it were stored in the first machine.

According to another aspect of the present invention there is provided a method of issuing and servicing a method call on a data object, the data object being defined according to a recognized database connectivity standard, wherein the database servicing the method call is remote from the application issuing the method call, the method comprising:

generating a command object in a proxy driver API component interfacing the application, the command object comprising properties of the method called by the application and an index to a relevant data object;

receiving the command object at a command handler component interfacing a data base by means of a database driver, and invoking the method properties of the command object such that the relevant data object is accessed based on the index;

transferring the issued method and relevant data object to the database driver; and

performing an operation in the database.

According to an aspect of the present invention, there is provided a method, system and computer program product relating directly to applications of object-oriented programming languages.

According to another aspect of the present invention, there is provided a method, system and computer program product comprising distributed components for manipulation of object-oriented systems.

According to another aspect of the present invention there is provided a method, system and computer program product in which a remote reference mechanism is provided in a component external to the component handling the classes to be accessed. An advantage of such an approach is compatibility with pre-existing drivers.

According to another aspect of the present invention there is provided a method, system and computer program product in which a method signature is known to the application and a method call is the initiating step. An advantage is that the proxy driver component may be used by an application in the same way as any database driver, such that it is not necessary to send explicit relay objects to the server object in order to gather information about methods of the class.

According to an aspect of the present invention, there is provided a method, system and computer program product which permits remote reference acquisition from objects of a pre-existent class and so allows ad-hoc remote access to a component.

The significance of those aspects is in the scope of the respective specifications. In preferred embodiments, any object belonging to the API of a component conforming to a common specification may be accessed remotely.

According to an aspect of the present invention, there is provided a method, system and computer program product which does not require remotely accessible objects to be of any special type.

Preferred embodiments, stipulate that object classes should belong to a published API specification. Preferably, information about classes is held in an API, which is implemented both on the client and in a component deployed on a server (for example, the database driver).

According to another aspect of the present invention there is provided a method, system and computer program product which connects to data sources separately and provides only the resources required for resource integration in an object oriented programming language, without itself performing the integration.

According to another aspect of the present invention there is provided a method, system and computer program product for supporting remote queries and transactions.

According to another aspect of the present invention, there is provided a method, system and computer program which does not require a facility to dynamically transfer transaction control from a number of disparate databases to a single, merged database.

According to another aspect of the present invention, there is provided a method, system and computer program product which supports JTA distributed transactions on different networks. Preferred embodiments achieve this because all objects instantiated by the database driver have parallel proxy objects, which can be stored remotely.

According to another aspect of the present invention, there is provided a method, system and computer program product including a mechanism for replacing an element expected on one machine with a pointer to the storage address of that element on a different machine.

According to another aspect of the present invention, there is provided a method, system and computer program product in which the proxy object contains a unique numeral reference to the data object in the server registry.

According to another aspect of the present invention there is provided a method, system and computer program product in which the class of the server object and the corresponding proxy object conform to a specification containing information about the methods of these classes.

According to an aspect of the present invention there is provided a method, system and computer program product for two-way communication between an existing application and a remote database driver, through a connection with security privileges determined by the administrator of the database.

According to another aspect of the present invention there is provided a remote database method and system comprising two distinct components, a Proxy Driver and Bridge residing close to the application and database respectively. The Bridge may operate in synchronous or asynchronous mode.

According to another aspect of the invention, the Proxy Driver component is accessed from the application through the same method call on the same class that the application would make if it were calling the database driver directly, and subsequent application code will require the return type specified in the method signature.

According to another aspect of the present invention, each method call is converted to a form suitable for sending across a wire protocol and wrapped in an object, together with an index reference to the object to which the method call was made. The wrapped object is then serialised and sent to the Bridge, where it is deserialised and unwrapped, and the information contained therein is converted to a method object that may be invoked using an established reflection mechanism. Any results returned by the method except data objects are serialised and returned to the Proxy Driver and thence to the application.

According to another aspect of the present invention, when a method call is received by the Bridge, a data object (defined as an object whose class belongs to the database driver API) previously stored in the registry is extracted and the method call invoked on it. If the method returns a data object, the object is entered into the registry and indexed by a unique key. This key is also returned to the Proxy Driver for use as an index reference in future registry look-ups, since such keys are low bandwidth it does not affect performance significantly.

According to another aspect of the present invention, the Bridge includes a mechanism for operation in asynchronous mode, in which case an index reference is returned to the Proxy Driver before the data object to which it will refer has been created. A number of references to future data objects may be rapidly created in this way, but if non-data objects or values are required from a data object that has not yet been created, there may be some delay whilst an entire hierarchy of data objects is created. On average, however, the use of this mode accelerates data processing considerably.

According to another aspect of the present invention, a method is provided in the Proxy Driver component for wrapping a new index reference to a data object (recently stored in the registry) as a proxy object, whose interface is identical to that of the data object. This allows the application to call the same methods on the new object as it would on an object returned from the database driver.

These, as well as other objects, features and benefits will now become clear from a review of the following detailed description of illustrative embodiments and the accompanying drawings.

### BRIEF DESCRIPTION OF THE DRAWINGS

An embodiment of the present invention will now be described by way of example only, with reference to the accompanying drawings in which:

FIG. 1 is a deployment diagram showing preferred Proxy Driver and Bridge components according to an embodiment of the present invention;

FIG. 2 is a class diagram of the Proxy Driver component;

FIG. 3 is a class diagram of the Bridge component;

FIG. 4 is a sequence diagram of the Bridge component, operating in synchronous mode;

FIG. 5 is a sequence diagram of the Bridge component (synchronous and asynchronous mode); and

FIG. 6 is a sequence diagram of the Bridge component, operating in asynchronous mode.

### DESCRIPTION OF THE PREFERRED EMBODIMENTS

This section is described in terms of the Java™ programming language. As customary, all Java™ classes, objects and methods have been set in the Courier typeface.

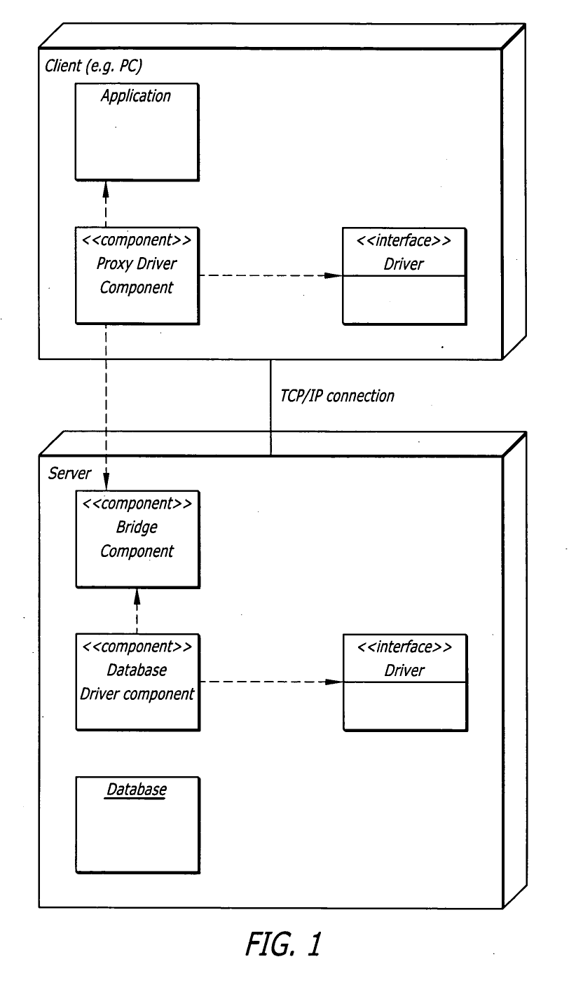

FIG. 1 shows the Database Proxy System, which is distributed software whose constituent components are deployed on two different networks connected by TCP/IP. For this section, the distributed environment will be described in terms of different networks to emphasise the physical deployment of components, whereas in the “Summary” section, where the logical view of the system is more important, the environment is described in terms of different virtual machines. Either view is valid, since the system will work on any TCP/IP network topology.

The Proxy Driver component implements a standard Database Connectivity (DBC) API such as JDBC® or ODBC, as should any database driver. This is indeed a requirement for the driver to be recognised as such by any other piece of software, and ensures that application and database are compatible and behave predictably together. It is reasonable to assume that most new drivers will continue to implement a standard DBC API for the foreseeable future and that existing applications will continue to use this API. To any application, the Proxy Driver appears identical to a database driver and hence it can be readily deployed in many situations.

Applications communicate through an API by means of method calls, which may accept parameters and may return new objects and values. Marshalling (serialising and sending) objects across TCP/IP is an established practice. Data objects, however, are often much larger than other objects and one data object in particular—the result set—causes many network bottlenecks. Furthermore, the DBC API has a branch structure in that each data object (except for the “ancestral” Driver object) has a parent object and may also have child objects. A long hierarchy of data objects needs to be instantiated before a single data record (such as a number) can be obtained. To overcome the speed reduction that would result from sending all the data objects across a wide-area network such as the Internet, the Database Proxy System returns only a numerical reference to each data object, whilst the object itself is never transferred. Usually, the storage of all objects would be managed by the application memory, but in this system data objects represent themselves to the application by means of small proxy objects, each of which contains a reference to the corresponding data object. The purpose of the Bridge component is to store and maintain a record of data objects returned by the database driver.

Description of the Proxy Driver

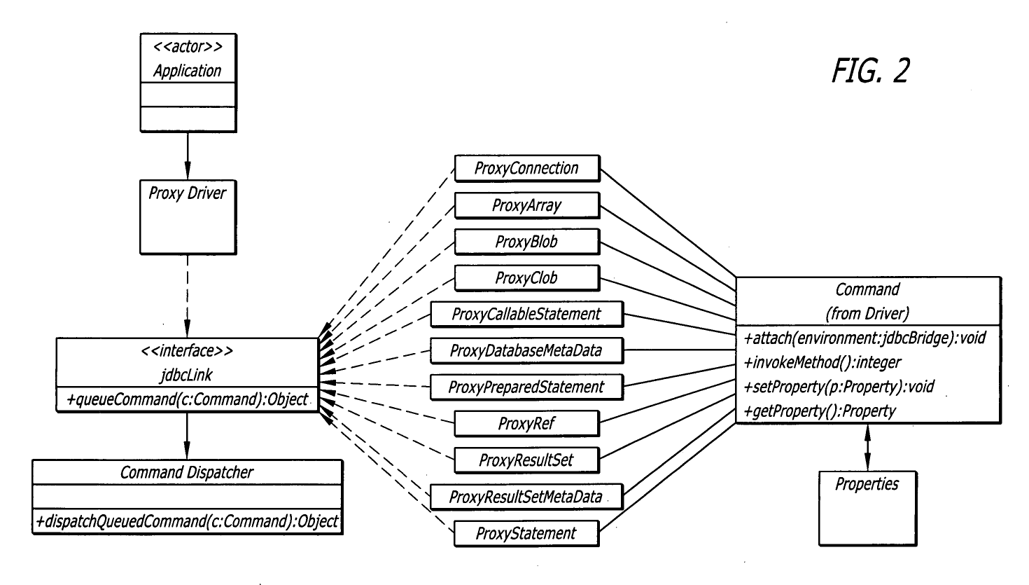

When disconnected from a database, the ProxyDriver object is the only object that can be created by the application, and it is from the driver that all other data objects are ultimately derived. The ProxyDriver object may be instantiated without a corresponding driver object on the Bridge. The name “proxy” has been retained as it may be considered a proxy after it has discovered, and obtained a connection to the database from its counterpart, the database driver. The proxy connection object is a hybrid, having characteristics both of a proxy object, such as a reference to the database connection, and of a data object, such as information about the network route to the database and transaction demarcations. The proxy connection has a direct association with the proxy driver, shown by the line between the ProxyDriver and ProxyConnection objects in FIG. 2.

Using the methods of the proxy connection, other proxy objects can be created. Method calls on proxy objects are transferred to the Bridge for invocation on the corresponding data object in the registry. When a method is called, the components of the method call and the object's index reference are set as properties in a command object for later retrieval by the Bridge component. The command is sent to a queue in a functional object called the command dispatcher. In order to ensure that proxy objects are able to queue the commands, all implement an interface containing the method queuecommand (c: Command), which is depicted in FIG. 2 by the dashed lines pointing to the class JdbcLink. This method in turn calls the command dispatcher, as shown by the line pointing from the JdbcLink to the CommandDispatcher class in FIG. 2. The CommandDispatcher manages the command queue by sending all commands to the Bridge in the order they are received.

If the signature of the method called includes a return type, the command dispatcher will return a reference, non-data object or primitive from the Bridge, which it passes to the proxy object that issued the command. If the returned object is a reference, the issuing proxy object sets the reference as the attribute of a new proxy object before returning it to the calling method in the application. If the return type is a primitive, the value is extracted from an object wrapper created by the bridge before returning, whilst if it is a non-data object it is simply returned “as-is”.

Description of the Bridge

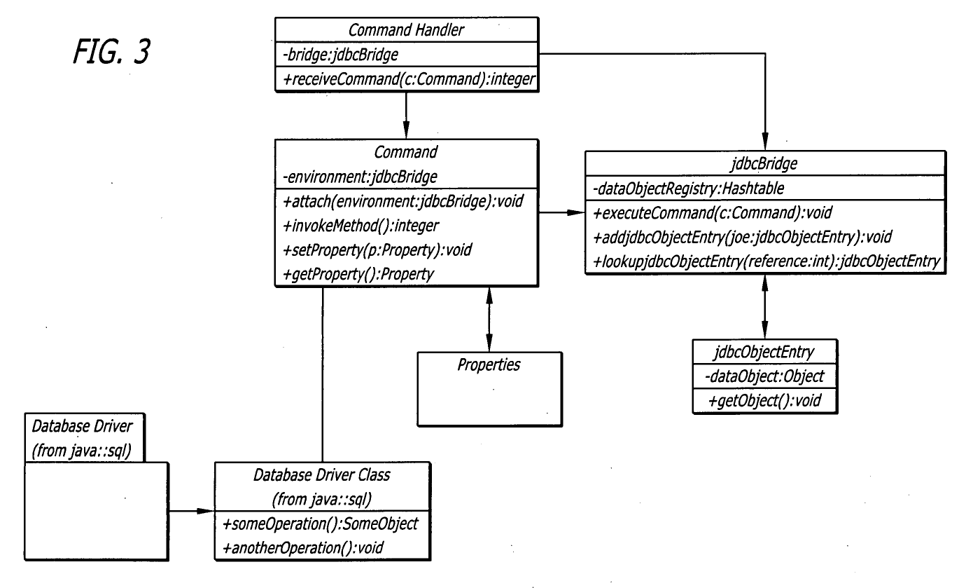

The Bridge can be regarded as a means for propagating a local database connection to a remote network and as such must maintain a continuous connection with a database. This is generated by a connection pool, and passed to the Bridge. The Bridge contains a registry where this and other data objects may be stored, looked up and extracted using an index reference. The registry is shown in FIG. 3 as the Hashtable dataobjectRegistry in the class JdbcBridge, together with its associated access methods. Data objects are wrapped in a class before being entered in the registry, which is shown as the JdbcObjectEntry. Instead of a data object, only this reference is returned to the Proxy Driver, a mechanism that results in much faster performance. The use of the asynchronous mode of operation, whereby the creation of proxy objects and their corresponding data objects is not synchronised, enhances performance still further. This is a significant benefit in situations where many actual data records, rather than the objects used to locate and retrieve them, are transferred, since the speed of transfer of the data records themselves does not benefit from the built-in accelerator mechanism, but does benefit from asynchronous operation.

A functional class of the Bridge, the CommandHandler receives commands and attaches the JDBCBridge class, containing the object registry and other attributes of the current state of the Bridge environment, to each command. This is shown by the arrows from the CommandHandler class to the Command class and to the JDBCBridge in FIG. 3. The command handler then invokes the method contained in the command by calling a method in a subclass of the Command class, the method invokeMethod( ):Integer, which prepares information about the method call before passing itself as a parameter to the executeCommand (c: Command):void in the JDBCBridge class. This method looks up the data object associated with the index reference in the data object registry, and invokes the method on this object. The method is passed to the database driver, which performs an operation in the database.

Control passes back to the Command class. If the method call has returned a data object, the invokeMethod( ):Integer method continues by generating a unique key, and entering this as an index reference, together with the data object, in the JDBCBridge class object registry. This key, which is a primitive integer value, is then wrapped in an Integer object and returned, via the command handler, to the Proxy Driver for use in future registry look-ups. If the method call returns a primitive value, it is wrapped in its associated wrapper class. A non-data object is returned “as-is”.

It is important to note that the implementation of a database connectivity system is the application of the Bridge considered here, but the referencing mechanism could be adapted for use with other APIs.

### DESCRIPTION OF THE DRAWINGS

FIG. 1

Deployment Diagram, Showing Proxy Driver and Bridge

FIG. 1 depicts the deployment of the components in the preferred embodiment. The hardware consists of a client and server, where each may be either a single machine or a network of machines.

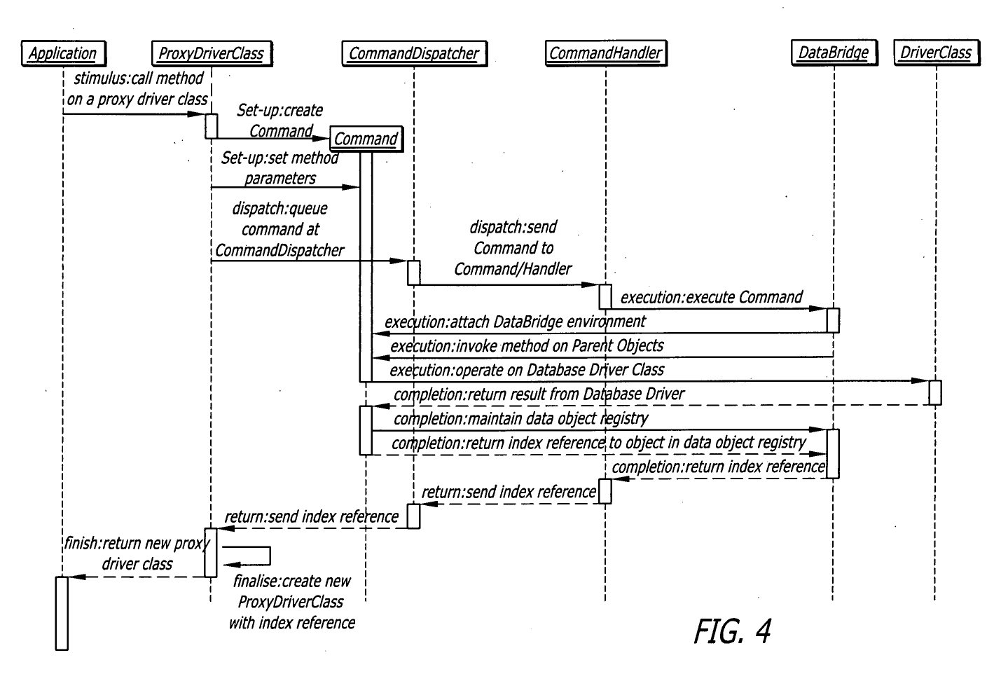

Of the components installed on the client hardware, the Proxy Driver component is shown implementing a Driver interface, which in the preferred embodiment is a DBC interface, thus furnishing an application with an API meeting a common specification. The application consults methods of the Driver interface, via the Proxy Driver component, in order to construct commands, pass them to the server for execution, and retrieve proxy objects holding numerical references to the results returned by the command execution. This mechanism is described more precisely in FIGS. 4-6.

In the preferred embodiment, the client and server hardware communicate via a TCP/IP connection. If the communication is over a public network, hardware or software gateways, firewalls and routers will normally be installed in order to handle network traffic. These are essential to the secure and reliable functioning of the system, but are not part of the patent and as such have not been shown on the diagram.

Of the components installed on the server hardware, the Bridge component receives commands from the Proxy Driver component and passes them to the Database-Specific Driver, which implements the Driver interface meeting the same common specification and implementing the same DBC interface as the Proxy Driver component. The Bridge also stores the results returned by the command execution and returns, to the Proxy Driver, a reference to the results. “Database-specific” is commonly referred to as “proprietary”, but the term is misleading as it may also include open source drivers.

FIG. 2

Class Diagram of Proxy Driver

FIG. 2 summarises the preferred embodiment of the Proxy Driver by showing its classes and the relationships between them.

Before connecting to the database, the ProxyDriver class is the only class available to the application. From this class, the application acquires a ProxyConnection, representing an actual connection to the database. Using the ProxyConnection, a hierarchy of DBC objects can be created as specified by the relevant DBC specification. All DBC objects (whose name starts with “Proxy”) implement both an interface of the DBC specification and the interface JdbcLink, which by virtue of a method queuecommand (Command c) ensures that all data classes have access to a method allowing them to queue their commands with the CommandDispatcher. The CommandDispatcher in turn dispatches queued commands to the CommandHandler (also known as the ServerBridge). Each of the DBC objects may create a Command, which contains the information necessary to carry out a given operation on the server when the Command arrives. This information is encapsulated as a Properties collection.

FIG. 3

Class Diagram of Bridge

FIG. 3 summarises the preferred embodiment of the Bridge by showing its classes and the relationships between them.

The CommandHandler has a method receiveCommand (Command c) which instructs the Command to attach to itself (i.e. create an attribute referring to) the JdbcBridge. The JdbcBridge contains information about the current state of the session, including a registry of the hierarchy of all stored DBC objects descended from the Connection. It also provides a public method allowing existing DBC objects to be retrieved and new ones to be added to a registry, and it is through a method of the JdbcBridge that a Command is executed. The Command encapsulates, in a Properties collection, information about the method originally called by the application, and the object upon which it was called, and a method call on the Command invokes this method. DBC objects are themselves encapsulated in a wrapper, JdbcObjectEntry, which allows meta-information about the object, such as parent objects, child objects and creation time, to be stored alongside it in the JdbcBridge. This information may be used to reconstitute the system state in the event of a server or client crash.

FIG. 4

Sequence Diagram of Bridge Operating in Synchronous Mode

FIG. 4 shows the dynamic operation of the entire system in synchronous mode, whereby each command must await the return of results before a new one can be issued.

The sequence is initiated by any object of an application calling a method on any object whose class belongs to the Driver API, indicated by the generic term “ProxyDriverClass”. This class creates a Command object encapsulating the object reference and the name of the method called. It then sets parameter type-value pairs by calling a method of the Command object. Lastly, it dispatches the Command to a single instance of a class known as CommandDispatcher. This prepares the Command for transmission and sends it (usually across a public network) to the CommandHandler, whose function is to look up the parent object in a registry. The registry is a collection (Hashtable) belonging to the JdbcBridge (also known as DataBridge). The parent object retrieval consists of three basic steps: firstly attaching the JdbcBridge, containing the collection of all parent objects, to the Command, secondly looking up the parent object required using the aforementioned object reference as an index and thirdly associating it with the Command. Execution is performed by calling a method of the Command on the parent object, which in turn invokes the method originally called by the application using the parameter type-value pairs, which were set on the client and which remain as attributes of the Command. The parent object consults its class in a Database-Specific Driver, shown here as DriverClass, and thereby retrieves a result from the database.

The method may return a new object whose class belongs to the DBC specification, in which case the Command is responsible for generating a new reference and storing the new object, with this reference as index, in a registry on the JdbcBridge. The JdbcBridge also returns the reference to the CommandHandler, which in turn returns it to the CommandDispatcher and thence to the ProxyDriverClass.

If the method does not return a DBC object, no reference is generated and the result returned reaches the client application “as is”. Notably, the return class of the methods of the Command, CommandHandler and CommandDispatcher cited above is always (in the preferred embodiment, in the Java programming language) Object, which is cast to an Integer if it is a reference, but which also allows other result types to be returned. If the method does not return a result, “null” is returned; if the method returns a non-DBC object, that object is returned, and if it returns a primitive, an object of the primitive wrapper class is returned.

The appropriate ProxyDriver class receives the result of the command as the return value of the dispatch method of the CommandDispatcher. It may then create a new “child” DBC object encapsulating the JdbcBridge index reference as an attribute, or, if the class of the returned object does not belong to the DBC specification, it will return the object retrieved from the database. If the return type is a primitive, the returned object will first be unwrapped by the ProxyDriver class, and then returned to the application. If the return type is null, no value is returned to the application.

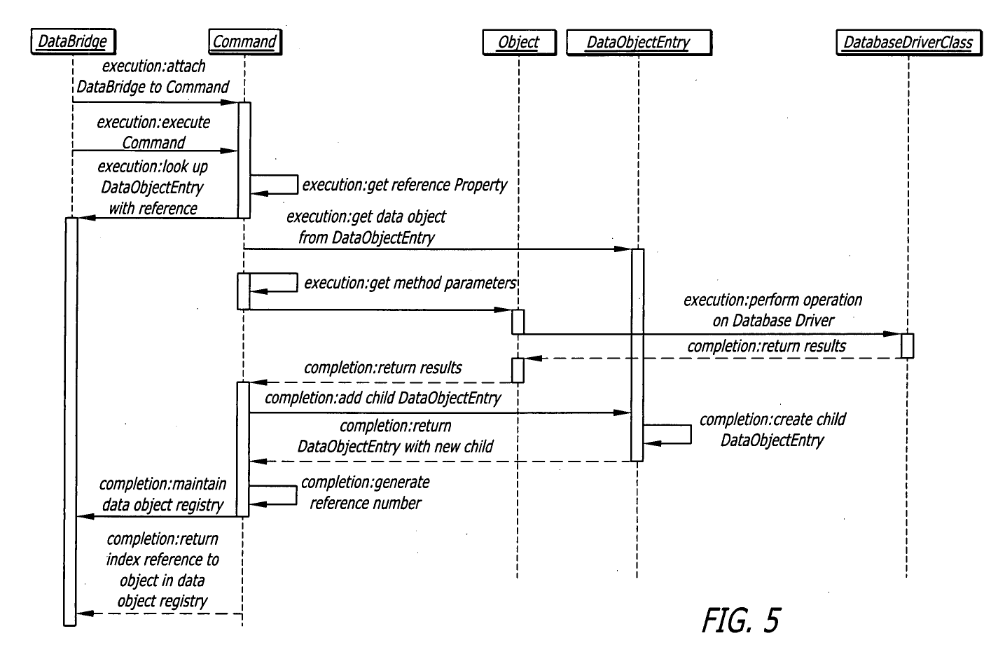

FIG. 5

Detailed Sequence Diagram of Bridge (Synchronous and Asynchronous Modes)

FIG. 5 shows the detailed dynamic operation of the classes JdbcBridge, Command and DataObjectEntry on the server machine, in which the issue of a new command by the application does not depend on the completion of the previous command.

The parent object, which is the object on which the method called by the application operates, is represented by a DataObjectEntry previously stored in the JdbcBridge. Before the command can be executed, the DataObjectEntry needs to be retrieved from the JdbcBridge in four steps: firstly attaching the JdbcBridge, containing the collection of all parent objects, to the Command, secondly acquiring the reference to the DataObjectEntry required, by means of a self-call within the Command, thirdly performing the actual look-up of the DataObjectEntry, fourthly retrieving the Object encapsulated in the DataObjectEntry and fifthly associating this Object with the Command. Execution is performed by a self-call in the Command aimed at acquiring the parameter type-value pairs, which were set on the client and which remain as attributes of the Command, then by calling a method of the Command, which in turn invokes the method originally called by the application using a reflection mechanism. The parent object consults its class in a Database-Specific Driver, shown here as DriverClass, and thereby retrieves a result from the database. The procedure for maintenance of the Bridge registry and returning the result to the application is identical to that described in FIG. 4.

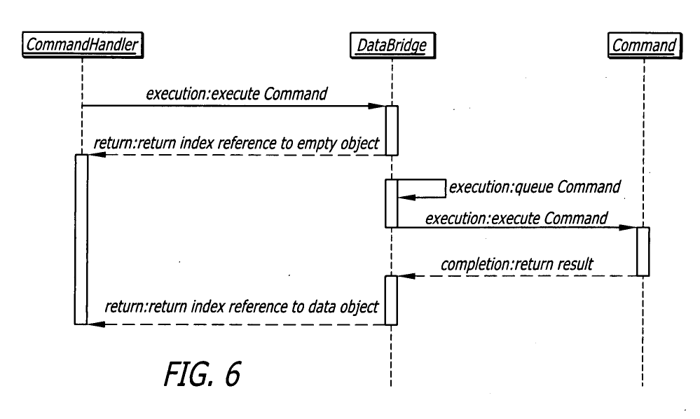

FIG. 6

Sequence Diagram of Bridge Operating in Asynchronous Mode

FIG. 6 shows the dynamic operation of the system server machine in asynchronous mode, whereby the issue of a new command by the application does not depend on the return of the previous command.

The purpose of the CommandHandler is to look up the parent object stored in a collection of the JdbcBridge (also known as DataBridge) and execute the Command. In asynchronous mode, it is possible that a parent object has not been created when it is required. In this case, when the executeCommand method of the JdbcBridge (also known as DataBridge) is called, an index reference is still returned to the CommandHandler, and thence to the ProxyDriver, exactly as described for synchronous operation. This reference may be used in a new DBC object, but does not yet refer to an actual object stored on the JdbcBridge.

In asynchronous operation, commands are continuously queued and executed by the Bridge. Once a real object is retrieved, it is stored in the JdbcBridge registry with a reference identical to that already returned to the ProxyDriver. When a non-DBC object or primitive is required by a Command (i.e. actual data for which a reference cannot be substituted), and the hierarchy of parent DBC objects required to retrieve it is not yet complete, the CommandHandler delays the execution of the Command until this hierarchy is complete.

Thus there is provided a mechanism which allows a software application implemented using an object-oriented language to instantiate, store and access data objects on a remote virtual machine (VM), defined as any VM distinct from the VM on which the software application runs, and connected thereto by means of TCP/IP. The conditions for this mechanism to work are that the aforementioned data objects' interfaces conform to a specific database connectivity specification and that their classes are implemented in a pre-existing database driver. Further, there is provided the mechanism above, wherein the API of the database driver held on the remote VM is identical to the API accessible to the driver and both are defined by a database connectivity specification.

It is essential to the continuous operation of an application that each data object on the remote VM has a corresponding data object, known as a proxy data object, made available to and stored in the memory of the application, and implementing the same interfaces as the remote data object. Using the mechanism, the application is able to call methods on the proxy data object, which are then executed on the remote data object.

An operation may be performed on a remote data object by method calls from the application. The said method calls are part of the Application Programming Interface (API) defined in the database connectivity specification implemented by a given database driver. The operation performed may instantiate a new object, or operate on or consult an existing object, and may return data objects, non-data objects and values to the application.

There is provided a mechanism for indexing and storing data objects in a registry, which permits any data object to be looked up, extracted from and returned to a registry.

In preferred embodiments, each data object is synchronised with its corresponding proxy data object by means of a numerical reference, which is held both as an attribute of the proxy data object and as an index key in the registry mentioned above. Registry look-ups may be performed using the reference held in the corresponding proxy data object.

It is possible to send method details from the proxy driver to the registry, wherein the details of every method belonging to the database connectivity specification API may be formulated and issued by each proxy data object and executed on the corresponding data object, both of which will in every instance have the same class belonging to the same API, but which are implemented differently, in the proxy driver and the database driver respectively.

Preferably method details are wrapped in a format that allows serialisation/de-serialisation and forwarding across a wire protocol. The method details so encapsulated are to be known as a command and include:

(a) a numerical reference to the proxy data object issuing the method call, which will be identical to the index key referencing the corresponding data object on the remote VM,

(b) the fully qualified name of an interface of the database connectivity specification implemented by the proxy driver from which the method call is issued, which is identical to the interface implemented by the data object in the registry of the remote VM,

(c) the method call's parameter class-value or primitive-value pairs and

(d) the method call's return type.

There may be two sub-procedures representing branches immediately subsequent to the above procedure. The sub-procedure followed during operation depends on the mode of operation, which may be set when the component is configured. The modes of operation, and the associated sub-procedures, are termed synchronous and asynchronous.

The synchronous sub-procedure may include of the following steps:

(a) the component of claim 8 consults the registry in order to extract the data object corresponding to the proxy object on which the method was called;

(b) the details of the method are then reconstituted from the command as disclosed above;

(c) the data object corresponding to the proxy object that issued the command, and having the same reference in the data object registry, is then extracted from the registry;

(d) the reflected method is then invoked on this data object, and

(e) the data object then executes the relevant method in the database driver.

The asynchronous sub-procedure may include of these steps in continuous rotating sequence:

(a) the command is added to a queue of commands pending execution;

(b) simultaneously generate and send, to the proxy object that issued the command, a reference to the object that will be instantiated and returned by the method at an unknown future time;

(c) this reference is simultaneously entered in the registry as a key to a null item;

(d) a (previously issued) command is then removed from the front of the queue;

(e) the details of the method are then reconstituted from the command as disclosed above;

(f) the method is then reflected (instantiated as an object);

(g) the data object corresponding to the proxy object that issued the command, and having the same reference in the data object registry, is then extracted from the registry, subject to the constraint below;

(h) the reflected method is then invoked on this data object, and

(i) the data object then executes the relevant method in the database driver.

In the preferred embodiment is incorporated a sub-mechanism designed to enforce a constraint in the asynchronous sub-procedure whereby it is not possible to extract a null object from the registry. This constraint will be enforced when these conditions are all met:

(a) a previously issued command remains in the queue of commands pending execution;

(b) the reference to the object that the command will instantiate at a future time is simultaneously;

(i) sent back to the proxy object that issued the command as a reference;

(ii) added to the registry as a key to a null item; and

(c) the reference has been received by this proxy object and a new proxy object has been instantiated, and

(d) a method is called on the new proxy object.

The new proxy object of condition (c) has no corresponding data object until the command of condition (a) has been executed and the data object returned by the driver has been entered in the registry. When methods are called on the new proxy object, the application will be unable to proceed beyond step (e) until the command of condition (a) has been executed and the data object returned from the database driver has been entered in the data object registry. Instead, it the command will be added to the aforementioned queue.

The mechanism includes:

(a) A thread responsible for intercepting a command and extracting the reference to the object that issued the command;

(b) Two alternative means of testing the above conditions for constraint enforcement. These are designed for reliability and speed respectively, and the test used can be set via a configuration file. The tests are:

(i) a test to check that all the above conditions are met;

(ii) a test that checks only whether there is a null object in the data registry for a given index reference (and assumes that the associated command is in the queue of commands pending execution);

(c) A method, called by the thread described in (a), which returns, to the back of the command queue, commands that were issued by a proxy object for which no data object yet exists.

There is also provided a mechanism whereby a programmatic object derived from a class that conforms to the specification of a resource driver can be accessed indirectly from a remote machine, by directly accessing a proxy object holding a reference to that object, in lieu of accessing the object itself.

A sequence for issuing a method call on a programmatic object derived from a resource driver class comprises the following steps: a programmatic call on a method of an actual object is made by a client on a proxy object, a command object is generated including the name and properties (e.g. parameters, parameter types, and parent class) of the method called, the command object is sent and received across a network, the actual object referenced by the proxy is retrieved from the database, the command object invokes the called method on this actual object, the operation contained in the method is performed on the resource; if an object is created by the said method it is stored in a registry and a reference thereto is returned to the client.

A further mechanism is that each method call from the application, once converted to a form suitable for sending across a wire protocol, is wrapped in an object capable of serialisation and deserialisation.

There is further provided a mechanism whereby a proxy component is accessed from the application through the same method call on the same class that the application would make if it were calling the resource directly, which has a means of returning an object or primitive whose class or type is of the type specified in the signature of the said method call.

A registry stores all objects returned by the resource accessed by the application, and has a mechanism for indexing the objects by means of a unique key. The unique key to the actual object is held as an attribute of the proxy object.

An actual object can be accessed by means of a proxy object.

An actual object stored by means of the mechanism described above may be extracted at any time and a method call invoked on it. Preferably, wherein the method called and reference to an object are encapsulated and transferred between processors, and whereby the object extracted, as described, is not required to be transferred between processors.

A system for creating, holding, referencing and accessing data objects from an application on a remote machine.

The claims described herein relate to a system allowing a software application to read, write and perform transactions using data stored in one or more distributed databases. The system consists of two interacting components, each embodying original inventions and both running on different machines. A component known as “Proxy Driver”, running on the same CPU and installed on the same machine as the client application, has an interface through which it receives method calls from the application and passes them via a network to another component, known as “Bridge”. This in turn actions the method calls in an installed, database-specific driver (henceforth to be known as “Database-Specific Driver”) and returns any result to the first component and thence to the application. One of the claims of this patent relates to one of the mechanisms enabling the interaction between these components.

Both the Proxy Driver and the existing Database-Specific driver meet the same specification, which is a Database Connectivity Application Programming Interface (DBC API), the purpose of which is to allow an application in an object-oriented language to read, write to, manipulate, and return results from a database using objects of that language. An object is commonly understood to be a structure of data attributes, whose format conforms to a class (or type) definition that includes methods to operate on those attributes. Several claims of this patent relate to the mechanisms whereby a new object created and returned by the Database-Specific Driver, whose class belongs to the DBC API, is stored on the server by means of the Bridge component, and a unique reference to this object is returned to the Proxy Driver on the client, allowing the object to be retrieved and used by the application as if it were stored in the memory of the machine on which the application is installed.

For the system to be usable, it must be possible for the application to cast any class of the Proxy Driver to the appropriate interface of the DBC API. In order to do so, the Proxy Driver includes a mechanism for wrapping the aforementioned references in objects whose classes also belong to this API and ensuring that these objects always implement the same interface as the object held on the bridge to which the reference relates. A further mechanism ensures that should there be a break in the network connection between Proxy Driver and Bridge, the application will resume normal operation immediately after reconnection. Further claims relate to these mechanisms.

The scope of the claims contained herein is database access. At the time of writing, only database drivers conform so closely and consistently to a given specification. The invention is, however, also applicable to any driver implementing an API for which a generally accepted specification exists, and for which remote access is required. Many of the claims contained herein will not, therefore, necessarily remain exclusive to databases and the scope of the invention is extensible.

Diagram Conventions

Diagrams in Unified Modelling Language (UML) illustrate the components and mechanisms comprising the system. UML is widely understood and is used to describe a great deal of software design at all levels of detail, hence any non-original elements to the system will be easy to spot elsewhere. The product and UML diagrams generally refer to Java, but could be implemented in any object-oriented language for which a DBC API has been developed.

A brief description of UML conventions, as they pertain to each type of diagram, follows.

UML Conventions in All Diagrams

Explanatory notes are written in a square box with the corner folded down, and a plain dashed line indicates the part of the diagram to which the note refers.

UML Conventions in Deployment Diagrams

A deployment diagram is understood to represent the physical configurations of the software and hardware for a given system.

The labelled three-dimensional rectangular boxes indicate hardware. The boxes within represent the installed parts of the system and the type of each part (if applicable) is written at the top of the box in parentheses.

Communication is depicted by a dashed line terminating in an arrow. The implementation of an interface is depicted by a dashed line from the implementing component terminating in a triangle pointing to the implemented interface.

UML Conventions in Class Diagrams

A class diagram is a static view of a system and does not show the effects of dynamic class interaction.

Classes, interfaces and components are represented by boxes. At the top of any box is a name and, if required, package and type. The plain boxes represent interfaces. Some interfaces are shown by a box with two compartments, the lower half showing the most important methods of the interface and the word <<interface>> added to indicate their type. Classes are shown by means of boxes with three compartments, where the middle compartment lists attributes and the lowest one shows methods of the class.

There are three kinds of relationship: association, aggregation and generalisation.

An association is a relationship between instances of two classes. There is an association between two classes if an instance of one class must know about the other in order to perform its work. In a diagram, an association is shown as a connecting link. An arrow indicates that a query may be performed by one class on another in order to discover its properties. A number at either end of an association indicates the range of possible instances of that class associated with a single instance at the other end.

Aggregation is a special form of association in which one class belongs to a collection. An aggregation has a diamond end pointing to the part containing the whole.

A generalisation is a link indicating that one class is a superclass of the other. A generalization has a triangle pointing to the superclass. An implemented interface is a form of generalisation, and is similarly represented by a triangle pointing to the interface, but the line is dashed.

UML Conventions in Sequence Diagrams

Sequence diagrams describe the dynamic behaviour of objects in collaboration. Sequence diagrams are organised according to time, which progresses down the page. The objects involved in the operation are listed from left to right according to when they take part in the sequence of events.

An object is shown as a box containing the name of its class. A vertical dashed line shows the time for which the object exists. An arrowed line depicts a message call. If a message activates an object, the time for which the object is activated is shown as a vertical bar. A message may be synchronous—waiting for its return call before proceeding—or asynchronous—in which the next message is processed immediately regardless of whether the current message has returned. Synchronous messages are shown by means of a solid arrowhead (i.e. triangle), asynchronous messages using a line arrowhead. An optional dashed line in the opposite direction shows a return call, although return calls may be omitted from the sequence diagram if they are not considered significant. A self-call is issued by an object in order to initiate an operation on itself, and is shown by an arrow first leaving and then turning back towards its origin.

What is claimed is:

1. A method for accessing a data object of a resource from an application located remotely from the resource, the method comprising:
issuing a method call from the application;
receiving the issued method call at a proxy driver located remotely from the resource;
generating a proxy command comprising a reference to the corresponding data object;
sending the proxy command over a communication channel to the resource; and
accessing the data object of the resource based on the proxy command.

2. The method of claim 1, wherein the communication channel provides two-way communication between an application and the remote resource so that commands can be sent and received over the channel.

3. The method of claim 1, wherein the communication channel is a TCP/IP link.

4. The method of claim 1, wherein the application and proxy driver are located in a client computer and the remote resource located is located in a server computer.

5. The method of claim 4, wherein the server computer comprises a bridge for receiving the proxy commands sent to the resource.

6. The method of claim 5, wherein the bridge is capable of operating in a synchronous mode whereby the command awaits a return of a result from the resource before a new command is generated.

7. The method of claim 5, wherein the bridge is capable of operating in an asynchronous mode whereby the step of generating a new command does not depend on a return of the result of the previous command

8. The method of claim 5, wherein the server computer also comprises a database proxy with interface between the bridge and resource.

9. The method of claim 4, wherein the client computer also comprises an interface associated with the proxy driver, said interface is the same as that of the database driver, and wherein both meet the same specification, which is a DBC API interface,

10. The method of claim 1, wherein the resource is a database.

11. The method of claim 1 wherein the data object is of a class that belongs to a same specification of an interface associated with a database driver located remotely from the specification.

12. The method of claim 1, wherein the proxy command generated includes the properties of the method call.

13. The method of claim 1, wherein each method call sent across the interface is wrapped in a format that allows serialization/deserialisation and forwarding across a wire protocol.

14. The method of claim 1, wherein the proxy component is accessed from the application through the same method call on a same class that the application would make if it were calling the resource directly, and wherein the method call having a signature that specifies a return type.

15. The method of claim 5, wherein the bridge comprises a registry for storing data objects returned by the resource accessed by the application and for indexing the data objects by means of a unique key.

16. The method of claim 15, wherein each data object is synchronized with its corresponding proxy data object by means of a numerical reference, which is held both as an attribute of the proxy data object and an index key in the registry.

17. The method of claim 1, wherein the application and proxy driver are located in a first communication network and the resource is located in a second network, said first and second networks being connected by the communication channel.

18. The method of claim 1, wherein the communication channel comprises security privileges determined by an administrator of the database.

19. The method of claim 5, wherein each method call is:
converted to a form suitable for sending across a communication protocol for a channel;
wrapped in an object, together with an index reference to the object to which the method call was made;
serializing the wrapped object;
sending to the bridge;
deserialized and unwrapped, and wherein information contained therein is converted to a method object that may be invoked using an established reflection mechanism.

20. A virtual machine running a software application implemented using an object-oriented language for performing an operation on a plurality of data objects of a remote virtual machine, the application comprising a memory arranged to store a plurality of proxy data objects each of which corresponding to the data objects of the remote virtual machine and implementing an interface which is the same as that for the remote data objects, wherein the application is arranged to call methods on the proxy data objects, which perform the operation on the data objects of the remote virtual machine.

21. The virtual machine of claim 20, wherein the interfaces conform to a specific database connectivity specification having classes that are implemented in a pre-existing database driver.

22. The virtual machine of claim 21, wherein the interface of the database driver on the remote virtual machine is the same as the interface accessible by the virtual machine running the software application, both being defined by the database connectivity specification.

23. The virtual machine of claim 20, wherein the operation performed is capable of instantiating a new data object, operating on or consulting an existing data object.

24. The virtual machine of claim 20, wherein the operation performed is capable of returning data objects, non-data objects and values to the application.

25. The virtual machine of claim 20, wherein the remote virtual machine comprises a bridge having a registry where the data objects are capable of being looked up, extracted from and returned to the registry using an index reference.

26. The virtual machine of claim 25, wherein the each of the data objects is synchronized with said corresponding proxy objects by a numerical reference, which is held both as an attribute of the proxy data object and as said index reference for the registry.

27. The virtual machine of claim 25, wherein look-ups of the registry are performed using the index reference held in the corresponding proxy data object.

28. The virtual machine of claim 20, wherein each proxy data object is smaller than the corresponding data object.

29. The virtual machine of claim 20, wherein each proxy data object comprises a reference to the corresponding data object.

30. A software application implemented using an object-oriented language to instantiate, store and access data objects on a remote virtual machine, the software application runs on a second virtual machine distinct from the remote virtual machine and connected thereto by means of TCP/IP, wherein the application having an proxy interface and the remote virtual machine having a database interface that conforms to a specific database connectivity specification having classes implemented in a pre-existing database driver.

31. A system for allowing an application to access a data object in a remote database, wherein a proxy driver component, also located remotely from the remote database, is accessed from the application program through a method call on a same class that the application would make if it were calling the remote database driver directly, wherein subsequent application code will require a return type specified in the signature.

32. A method of issuing and servicing a method call from an application to a data object in a remote database, wherein a proxy driver and bridge reside close to the application and database respectively, and wherein the proxy driver component is accessed from the application through the same method call on a same class that the application would make if it were calling the database driver directly.

33. A system for accessing remote data objects, the system comprising:
a first machine comprising an application and a proxy driver with an interface, wherein the interface receiving method calls from the application;
a network connecting the first machine to a second machine;
the second machine comprising a bridge, a database driver with an interface and a database, wherein the bridge stores data objects returned by the database driver from the database in response to previous method calls and the bridge further comprising a registry with an index reference to the data objects stored in the bridge.

34. The system of claim 33, wherein the proxy driver with interface and the database driver with interface meet the same specification, which is a DBC API, and wherein such an arrangement allows the application using an object-oriented language to read, write to, manipulate and return results from the database using objects of said language.

35. The system of claim 33, wherein a new data object of a certain class is created and returned by the database driver having the same class, and is stored in the bridge of the second machine, said bridge returning a unique reference of the new data object to the proxy driver on the first machine, thereby allowing the new data object to accessed by the application as if it were stored in the first machine.

36. A method of issuing and servicing a method call on a data object, the data object being defined according to a recognized database connectivity standard, wherein the database servicing the method call is remote from the application issuing the method call, the method comprising:
(a) generating a command object in a proxy driver API component interfacing the application, the command object comprising properties of the method called by the application and an index to a relevant data object;
(b) receiving the command object at a command handler component interfacing a data base by means of a database driver, and invoking the method properties of the command object such that the relevant data object is accessed based on the index;
(c) transferring the issued method and relevant data object to the database driver; and
(d) performing an operation in the database.
